(19) United States
(12) Patent Application Publication
(10) Pub. No.: US 2026/0071650 A1
(43) Pub. Date: Mar. 12, 2026

(54) Vibration Isolation Structure

(71) Applicant: NOK CORPORATION, Tokyo (JP)

(72) Inventor: Naoya IWATA, Tottori (JP)

(21) Appl. No.: 19/241,616

(22) Filed: Jun. 18, 2025

(30) Foreign Application Priority Data
Sep. 9, 2024 (JP) 2024-154903

(51) Int. Cl. F16C 27/06

(52) U.S. Cl. CPC F16C 27/066

(57) ABSTRACT

A vibration isolation structure includes a shaft, a rolling bearing, a support, and a vibration isolator. The rolling bearing includes an inner ring fitted on the shaft and including an inner end face, and an outer ring including an outer end face facing in an axial direction, an outer diameter portion facing radially outward, and an outer corner connecting the outer diameter portion and the outer end face. The support includes a fitting portion fitted on the outer ring, and a facing portion facing the inner end face or the outer end face. The vibration isolator is annular and received in a space defined by the fitting portion, the facing portion, and the outer corner. The vibration isolator is in contact with the outer corner and applies an elastic force acting in a radial direction and in the axial direction to the outer ring.

### CROSS-REFERENCE TO RELATED APPLICATIONS

This application claims priority to Japanese Patent Application No. 2024-154903, filed on Sep. 9, 2024, which is expressly incorporated herein by reference in its entirety.

### BACKGROUND

### 1. Technical Field

The present invention relates to a vibration isolation structure.

### 2. Description of the Background

A known bearing device installed on a drive shaft of, for example, an automobile includes an elastic member (elastomer) surrounding a rolling bearing (e.g., Japanese Unexamined Patent Application Publication No. 10-299785). The drive shaft transmits power from a power unit or a transmission to wheels with tires. The power unit includes, for example, a motor and an internal combustion engine. The elastic member surrounding the rolling bearing serves as, in such a bearing device, a vibration isolator that reduces vibration resulting from rotation of the rolling bearing.

One factor for vibration resulting from rotation of the rolling bearing is misalignment of the rotation axis of the rolling bearing. One factor for misalignment of the rotation axis of the rolling bearing is an internal clearance between rolling elements and an outer ring or an inner ring in the rolling bearing. When the rolling bearing is installed with its axis extending in the horizontal direction, as on a drive shaft, the internal clearance may differ between an upper portion and a lower portion of the rolling bearing in the vertical direction under the gravity, increasing the misalignment of the rotation axis of the rolling bearing.

To reduce the internal clearance of the rolling bearing, an external force is applied to the outer ring or the inner ring to press it against the rolling elements in the axial direction. Pressing an elastomer vibration isolator against the outer ring of the rolling bearing in the axial direction reduces the internal clearance of the rolling bearing. However, the vibration resulting from the rolling bearing can be reduced only in the axial direction. To reduce the vibration resulting from the rolling bearing and acting in the radial direction with the elastomer vibration isolator pressed against the outer ring of the rolling bearing in the axial direction, an additional vibration isolator is to be placed adjacent to the bearing in the radial direction.

### SUMMARY

One or more aspects of the disclosure are directed to a vibration isolation structure for reducing transmission of vibration from a rolling bearing located between a shaft and a support and reducing misalignment of the rotation axis of the rolling bearing with a simple structure.

An aspect of the disclosure provides a vibration isolation structure, comprising:
a shaft extending in an axial direction;
a rolling bearing including
   an inner ring fitted on the shaft, the inner ring including an inner end face facing in the axial direction, and
   an outer ring located radially outward from the inner ring, the outer ring including
      an outer end face facing in the axial direction,
      an outer diameter portion facing radially outward, and
      an outer corner connecting the outer diameter portion and the outer end face;
a support supporting the rolling bearing, the support including
   a fitting portion fitted on the outer ring, and
   at least one facing portion facing the inner end face or the outer end face; and
a vibration isolator being annular and received in a space defined by the fitting portion, the at least one facing portion, and the outer corner, the vibration isolator being in contact with the outer corner and applying an elastic force acting in a radial direction and in the axial direction to the outer ring.

The technique according to the above aspect of the disclosure can reduce transmission of vibration from the rolling bearing located between the shaft and the support and reduce misalignment of the rotation axis of the rolling bearing with a simple structure.

### BRIEF DESCRIPTION OF THE DRAWINGS

FIG. 1 is a cross-sectional view of a vibration isolation structure according to an embodiment.

FIG. 2 is a cross-sectional view of a vibration isolator in the embodiment.

FIG. 3 is a cross-sectional view of a vibration isolator in a modification of the embodiment.

FIG. 4 is a cross-sectional view of a bearing in a modification of the embodiment.

FIG. 5 is a cross-sectional view of a bearing and a vibration isolator in a modification of the embodiment.

FIG. 6 is a cross-sectional view of a vibration isolation structure according to a modification of the embodiment.

FIG. 7 is a cross-sectional view of a vibration isolation structure according to a modification of the embodiment.

FIG. 8 is a cross-sectional view of a vibration isolator in the modification of the embodiment.

FIG. 9 is a cross-sectional view of a vibration isolation structure according to a modification of the embodiment.

FIG. 10 is a cross-sectional view of a vibration isolation structure according to a modification of the embodiment.

### DETAILED DESCRIPTION

One or more embodiments of the disclosure will now be described with reference to the drawings. The drawings may not be precisely drawn to scale, and one or more features may be exaggerated or not shown.

A vibration isolation structure according to one or more embodiments of the disclosure is used in a structure (not shown) installed on a rotational shaft of, for example, an automobile. The rotational shaft is, for example, a drive shaft included in a power unit or a transmission. The power unit includes, for example, a motor and an internal combustion engine.

The X-direction hereafter refers to a direction along the axis of a rolling bearing. The negative X-direction refers to a direction in which the rolling bearing received in a fitting portion faces the bottom of the fitting portion. The fitting portion is a recess that is open in the axial direction. The positive X-direction refers to a direction opposite to the negative X-direction. Being radially outward refers to a direction away from the central axis of the rolling bearing. Being radially inward refers to a direction toward the central axis of the rolling bearing.

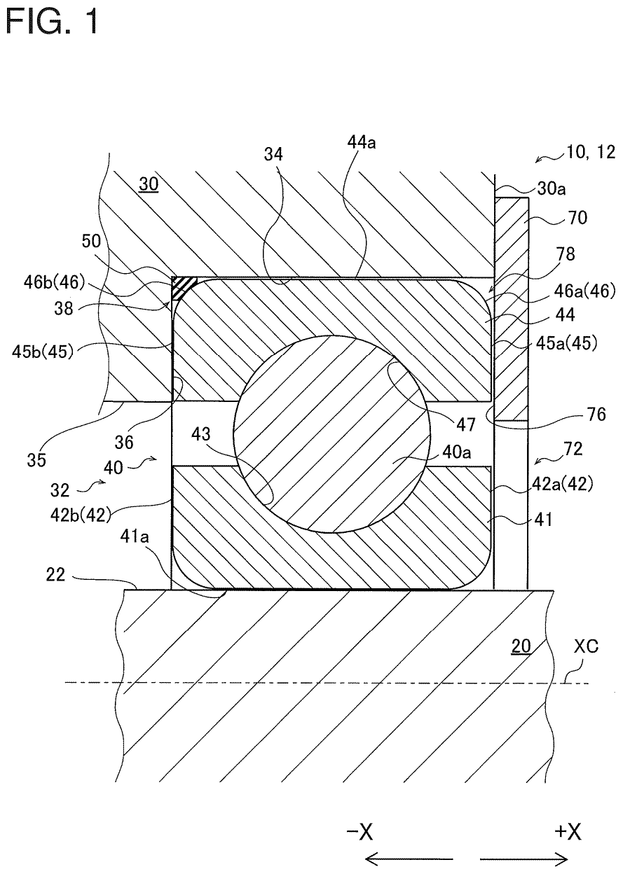

A structure 10 according to an embodiment includes a shaft 20, a bearing 40, a support 30, a fixture 70, and a vibration isolator 50, as shown in FIG. 1. The shaft 20, the bearing 40, the support 30, and the vibration isolator 50 are included in a vibration isolation structure 12.

The shaft 20 is cylindrical and extends uniformly along an axis XC. The axis XC is an imaginary centerline extending in the X-direction. The shaft 20 has a side surface 22. The shaft 20 is connected to a drive (not shown). The drive includes a motor, a transmission, or both. The shaft 20 is rotatable about the axis XC with the drive. The shaft 20 is at a predetermined position relative to the bearing 40 or the support 30 (described later) with a known positioner (not shown).

The bearing 40 is a rolling bearing installed on the shaft 20. The rolling bearing in one or more embodiments of the disclosure is a radial bearing. The bearing 40 is a ball bearing. The rolling bearing in one or more embodiments of the disclosure is not limited to a ball bearing, and may be any radial rolling bearing. The bearing 40 may be a spherical rolling bearing.

The bearing 40 is supported in a hole 32 in the support 30 (described later).

The bearing 40 includes multiple rolling elements 40a, an inner ring 41, and an outer ring 44. The rolling elements 40a in the bearing 40 being a ball bearing are spherical. The multiple rolling elements 40a are annularly arranged about the shaft 20 along a rolling surface 43 of the inner ring 41 (described later) and a rolling surface 47 of the outer ring 44 (described later).

The inner ring 41 is annular and fitted on the shaft 20. The inner ring 41 is between the rolling elements 40a and the shaft 20. The inner ring 41 includes an inner diameter portion 41a, inner end faces 42, and a first rolling surface 43.

The inner diameter portion 41a is a cylindrical portion of the annular inner ring 41 that faces radially inward. The inner diameter portion 41a is fitted on the side surface 22 of the shaft 20. The inner ring 41 is thus integrally rotatable with the shaft 20 about the axis XC.

The inner end faces 42 extend radially outward from two axial ends of the inner diameter portion 41a. The inner end faces 42 include an inner end face 42a and an inner end face 42b. The inner end face 42a faces in the positive X-direction. The inner end face 42b faces in the negative X-direction.

The first rolling surface 43 is an annular surface located radially outward from the inner diameter portion 41a and faces radially outward. The first rolling surface 43 of the bearing 40 being a ball bearing is semi-circular in conformance with the surface of the spherical rolling element 40a in a cross-sectional view shown in FIG. 1.

The outer ring 44 is annular and located radially outward from the inner ring 41 with the rolling elements 40a between them. The outer ring 44 is between the rolling elements 40a and the support 30. The outer ring 44 is out of contact with the inner ring 41. The outer ring 44 includes an outer diameter portion 44a, outer end faces 45, outer corners 46, and a second rolling surface 47.

The outer diameter portion 44a is a cylindrical portion of the annular outer ring 44 that faces radially outward. The outer diameter portion 44a is fitted in the hole 32 in the support 30.

The outer end faces 45 extend radially inward from two axial ends of the outer diameter portion 44a. The outer end faces 45 include an outer end face 45a and an outer end face 45b. The outer end face 45a faces in the positive X-direction. The outer end face 45b faces in the negative X-direction.

The outer corners 46 are annular and connect the outer diameter portion 44a and the outer end faces 45. The outer corners 46 are curved surfaces that are rounded. The outer corners 46 include an outer corner 46a and an outer corner 46b. The outer corner 46a faces in the positive X-direction. The outer corner 46b faces in the negative X-direction.

The second rolling surface 47 is an annular surface located radially inward from the outer diameter portion 44a and faces radially inward. The second rolling surface 47 of the bearing 40 being a ball bearing is semi-circular in conformance with the surface of the spherical rolling element 40a in a cross-sectional view shown in FIG. 1.

The support 30 supports the shaft 20 with the bearing 40 between them. The support 30 includes an outer surface 30a, the hole 32, and the fixture 70. The outer surface 30a faces in the positive X-direction.

The hole 32 is cylindrical and extends through the support 30 in the X-direction. The hole 32 includes a larger-diameter portion 34, a smaller-diameter portion 35, a step surface 36, and a first corner 38.

The larger-diameter portion 34 is a cylindrical hole that is open on the outer surface 30a. The larger-diameter portion 34 is fitted on the outer diameter portion 44a of the bearing 40. The larger-diameter portion 34 is an example of a fitting portion. The support 30 supports the bearing 40 on the larger-diameter portion 34 of the hole 32.

The smaller-diameter portion 35 is a cylindrical hole farther from the outer surface 30a than the larger-diameter portion 34. The smaller-diameter portion 35 is open on the step surface 36 (described later). The smaller-diameter portion 35 is concentric with the larger-diameter portion 34. The smaller-diameter portion 35 has a diameter larger than the diameter of the shaft 20 and smaller than the diameter of the larger-diameter portion 34. The inner end face 42b of the bearing 40 fitted in the larger-diameter portion 34 is exposed in the smaller-diameter portion 35.

The step surface 36 is flat and connects the larger-diameter portion 34 and the smaller-diameter portion 35. In other words, the step surface 36 is between the larger-diameter portion 34 and the smaller-diameter portion 35. The step surface 36 faces in the positive X-direction. With the bearing 40 received in the hole 32, the step surface 36 faces the outer end face 45b of the outer ring 44. The step surface 36 is an example of a first facing portion. In the vibration isolation structure 12 in the structure 10, the step surface 36 overlaps only the outer end face 45 in the axial direction. In other words, the step surface 36 does not face the inner end face 42b of the inner ring 41.

The first corner 38 is annular and connects the larger-diameter portion 34 and the step surface 36. The first corner 38 is defined between the larger-diameter portion 34 and the step surface 36. The first corner 38 may be a curved surface that is rounded.

The fixture 70 is located adjacent to the outer surface 30a as a separate member. The fixture 70 is an annular plate. The fixture 70 is attached to the support 30 with fasteners (not shown). The fasteners are, for example, a bolt and a nut. The fixture 70 prevents the bearing 40 received in the hole 32 from dropping off the hole 32. The fixture 70 has a central hole 72 and an engaging surface 76. The fixture 70 and the support 30 define a second corner 78 between them.

The central hole 72 defines a cylindrical surface of the annular fixture 70 that faces radially inward. The central hole 72 has a diameter larger than the diameter of the shaft 20 and smaller than the diameter of the larger-diameter portion 34.

The engaging surface 76 faces in the negative X-direction. With the bearing 40 received in the hole 32, the engaging surface 76 faces the outer end face 45a of the outer ring 44. The engaging surface 76 is an example of a second facing portion. The engaging surface 76 overlaps only the outer end face 45 in the axial direction. The engaging surface 76 may further face the inner end face 42a of the inner ring 41. In other words, the engaging surface 76 may further overlap the inner end face 42 in the axial direction.

The second corner 78 is a space defined as a corner between the engaging surface 76 and the larger-diameter portion 34 of the hole 32.

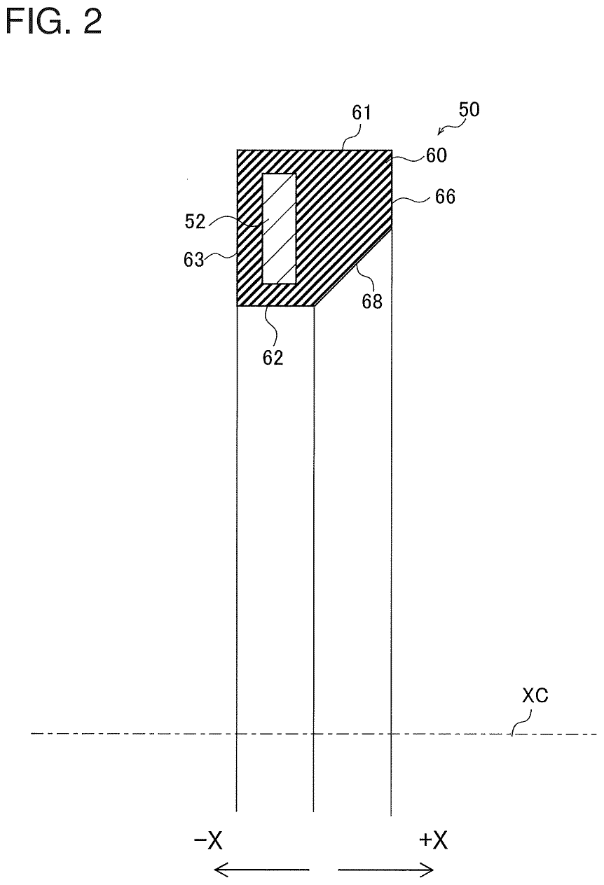

The vibration isolator 50 is annular and received in a space defined by the large-diameter portion 34 of the support 30, the step surface 36, and one of the outer corners 46 of the bearing 40. More specifically, the vibration isolator 50 is received in the first corner 38 of the hole 32 receiving the bearing 40. The vibration isolator 50 includes a core 52 and a body 60, as shown in FIG. 2.

The core 52 is annular and located about the axis XC. The core 52 has higher rigidity than the body 60. The core 52 may be formed from metal. The core 52 may be formed from rolled steel (e.g., steel plate cold commercial or SPCC) or stainless steel.

The body 60 is annular and surrounds the core 52 as its core. The body 60 is formed from an elastomer or a thermoplastic resin. The elastomer may be, for example, ethylene propylene rubber (ethylene propylene diene monomer or EPDM), acrylic rubber (alkyl acrylate copolymer or ACM), nitrile rubber (nitrile butadiene rubber or NBR), or fluoro rubber (fluorine kautschuk material or FKM).

As shown in FIG. 2, the body 60 has a pentagonal cross section corresponding to a rectangle with a chamfered corner. The body 60 includes an outer circumferential portion 61, an inner circumferential portion 62, a bottom 63, a distal end 66, and a slope 68.

The outer circumferential portion 61 is a cylindrical surface of the body 60 that faces radially outward. The outer circumferential portion 61 is in contact with the larger-diameter portion 34 of the support 30.

The inner circumferential portion 62 is a cylindrical surface of the body 60 that faces radially inward. The inner circumferential portion 62 is shorter than the outer circumferential portion 61 in the axial direction.

The bottom 63 connects the end of the outer circumferential portion 61 and the end of the inner circumferential portion 62 in the negative X-direction. The bottom 63 in the vibration isolation structure 12 connects the end of the outer circumferential portion 61 and the end of the inner circumferential portion 62 in the negative X-direction. The bottom 63 faces in the negative X-direction. The bottom 63 is in contact with the step surface 36 of the support 30.

The distal end 66 extends radially inward from the end of the outer circumferential portion 61 in the positive X-direction. The distal end 66 faces in the positive X-direction. The distal end 66 is shorter than the bottom 63 in the radial direction.

The slope 68 is a sloping surface connecting the distal end 66 and the inner circumferential portion 62. The slope 68 linearly slopes with respect to the axial direction in a cross-sectional view. The slope 68 faces radially inward and also faces in the positive X-direction. The slope 68 faces and is in contact with the outer corner 46b of the bearing 40. The slope 68 is an example of a facing surface.

The vibration isolator 50 received in the first corner 38 has the body 60 that elastically deforms while being in contact with the outer corner 46 of the bearing 40. The vibration isolator 50 transmits an elastic force resulting from the elastic deformation of the body 60 to the outer ring 44 through the slope 68 and the outer corner 46. The elastic force is transmitted radially inward and in the positive X-direction from the outer corner 46 to the outer ring 44. In other words, the vibration isolator 50 in contact with the outer corner 46 applies an elastic force acting in the radial direction and in the axial direction to the outer ring 44.

The vibration isolator 50 may not include the core 52 when the vibration isolator 50 in contact with the outer corner 46 can apply an elastic force acting in the radial direction and in the axial direction to the outer ring 44.

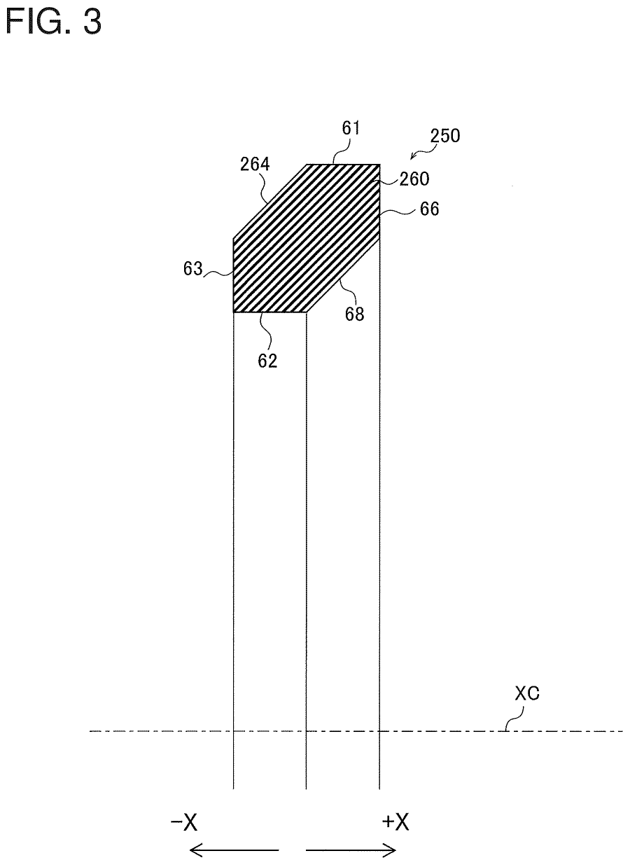

The vibration isolator in one or more embodiments of the disclosure may not have a pentagonal cross section as described above when the vibration isolator in contact with the outer corner 46 can apply an elastic force acting in the radial direction and in the axial direction to the outer ring 44. The vibration isolator in one or more embodiments of the disclosure may have, for example, a hexagonal cross section as a vibration isolator 250 shown in FIG. 3. More specifically, the vibration isolator 250 further includes a slope 264, unlike the vibration isolator 50. The slope 264 is a linear sloping surface in a cross-sectional view. The slope 264 corresponds to a chamfered corner connecting the outer circumferential portion 61 and the bottom 63 of the vibration isolator 50. The vibration isolator 250 with the slope 264 can be prevented from being received unstably under interference with the first corner 38 being a curved surface that is rounded.

The vibration isolator in one or more embodiments of the disclosure may not have a facing surface such as the slope 68 when the vibration isolator in contact with the outer corner 46 can apply an elastic force acting in the radial direction and in the axial direction to the outer ring 44. The vibration isolator in one or more embodiments of the disclosure may have a thick arc cross section that is curved along the outer corner 46 of the bearing 40. The vibration isolator in one or more embodiments of the disclosure may have a solid circular cross section.

### Advantages and Effects

The advantages and effects of the vibration isolation structure 12 according to the first embodiment will now be described. The vibration isolator 50 in the vibration isolation structure 12 applies an elastic force acting radially inward and in the axial direction (in the positive X-direction) to the outer ring 44 in the bearing 40 while being in contact with the slope 68 and the outer corner 46. The axial component of the elastic force resulting from the contact between the slope 68 and the outer corner 46 moves the outer ring 44 in the positive X-direction. The radial component of the elastic force acts as a pressure acting radially inward on the annular outer ring 44. The inner ring 41 in the bearing 40 is in contact with only the rolling elements 40a and the shaft 20. Applying an elastic force from the vibration isolator 50 to the outer ring 44 thus reduces an internal clearance of the bearing 40. In particular, under a load applied to the inner ring 41 in the negative X-direction through the shaft 20 and an elastic force applied to the outer ring 44, the internal clearance of the bearing 40 decreases. Misalignment of the rotation axis of the bearing 40 decreases as the internal clearance of the bearing 40 decreases.

The slope 68 of the vibration isolator 50 in the vibration isolation structure 12 is in contact with the outer ring 44 in the bearing 40. The vibration isolator 50 thus reduces both the radial and axial components of vibration resulting from the bearing 40.

Thus, the vibration isolation structure 12 can reduce transmission of vibration from the bearing 40 located between the shaft 20 and the support 30 and reduce the misalignment of the rotation axis of the bearing 40 with a simple structure.

The vibration isolator 50 includes the core 52 and the body 60. The vibration isolator 50 in the vibration isolation structure 12 can thus increase an elastic force resulting from the elastic deformation of the body 60 and effectively apply the elastic force to the bearing 40.

The vibration isolator 50 includes the slope 68. The vibration isolator 50 in the vibration isolation structure 12 can thus more effectively apply an elastic force resulting from the elastic deformation of the vibration isolator 50 to the bearing 40.

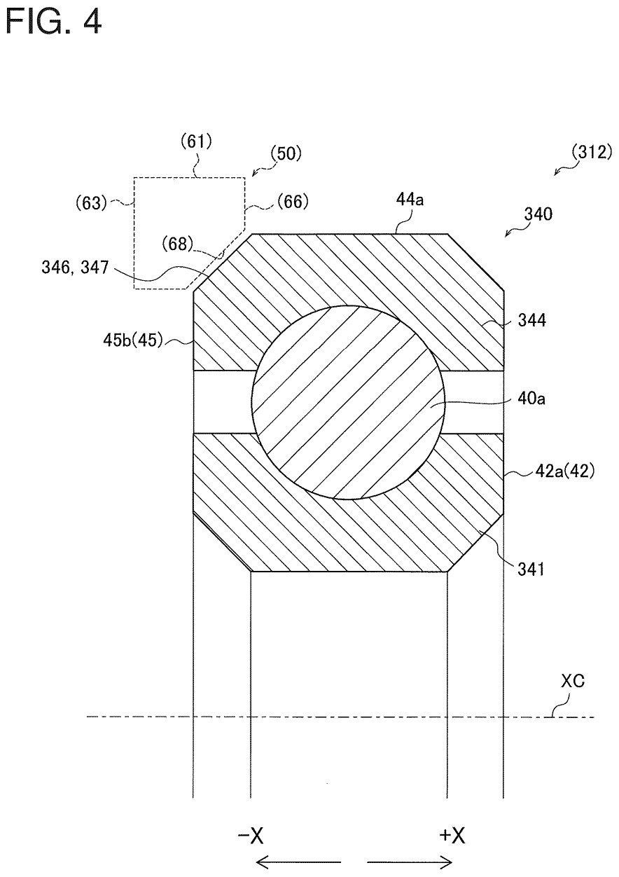

The bearing in one or more embodiments of the disclosure may include an outer ring with a chamfer 347, similarly to a bearing 340 in a vibration isolation structure 312 shown in FIG. 4. The chamfer 347 is formed by chamfering a corner at which the outer diameter portion 44a and the outer end face 45 meet orthogonally to each other. The chamfer 347 linearly slopes with respect to the axial direction in a cross-sectional view. The chamfer 347 connects the outer diameter portion 44a and the outer end face 45. In other words, an outer corner 346 of the bearing 340 is the chamfer 347. The chamfer 347 faces radially outward and in the negative X-direction.

With this structure, the bearing 340 in the vibration isolation structure 312 can effectively apply an elastic force from the vibration isolator 50 to the outer ring 44 as an external force acting with the radial and axial components.

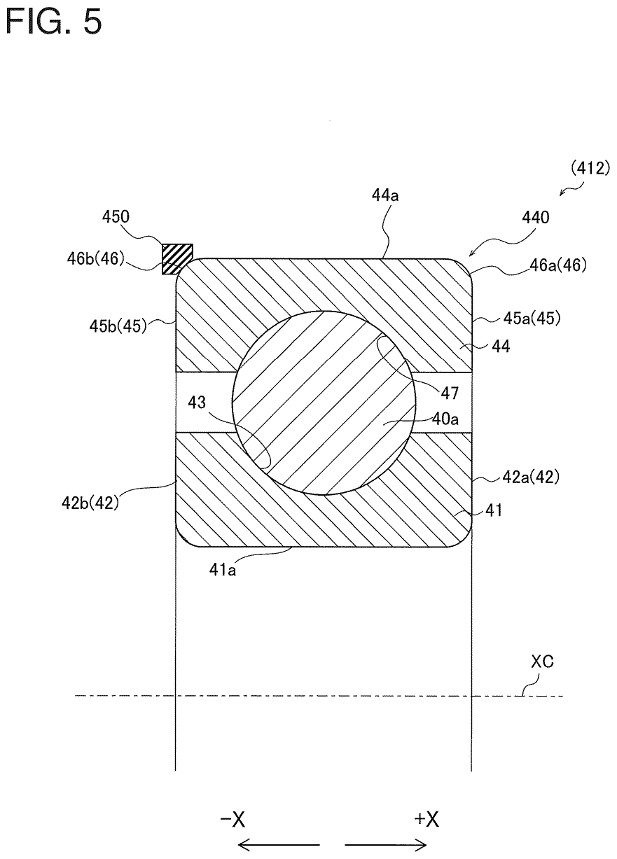

The bearing and the vibration isolator in one or more embodiments of the disclosure may be a bearing 440 and a vibration isolator 450 integrally fixed to each other in a vibration isolation structure 412 shown in FIG. 5. More specifically, the vibration isolator 450 may be integral with the outer corner 46 of the bearing 440. The vibration isolator 450 has the slope 68 bonded to the outer corner 46 with, for example, an adhesive.

With this structure, the bearing 440 and the vibration isolator 450 can be handled as one piece during assembling the vibration isolation structure 412. Thus, the vibration isolation structure 412 with the bearing 440 and the vibration isolator 450 can be assembled more easily.

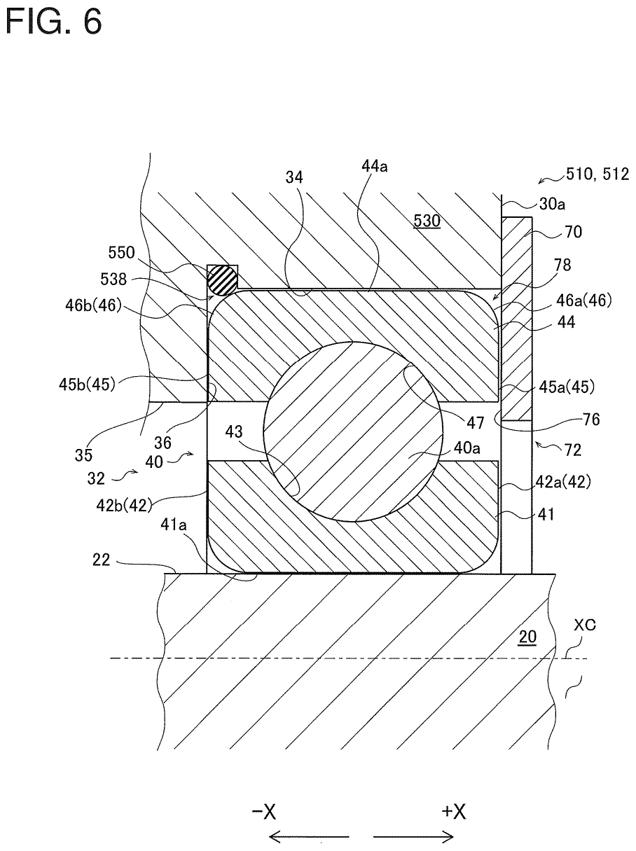

The first corner in one or more embodiments of the disclosure may be an undercut 538 in a vibration isolation structure 512 shown in FIG. 6. The undercut 538 is an annular groove being a recess that is open on the larger-diameter portion 34. The undercut 538 includes a groove wall substantially flush with the step surface 36. In other words, the undercut 538 is between the larger-diameter portion 34 and the step surface 36.

The vibration isolation structure 512 can receive a vibration isolator 550 in the undercut 538. The vibration isolator 550 in the vibration isolation structure 512 can be larger than the vibration isolator 50 in the vibration isolation structure 12 by a volume corresponding to the space in the undercut 538.

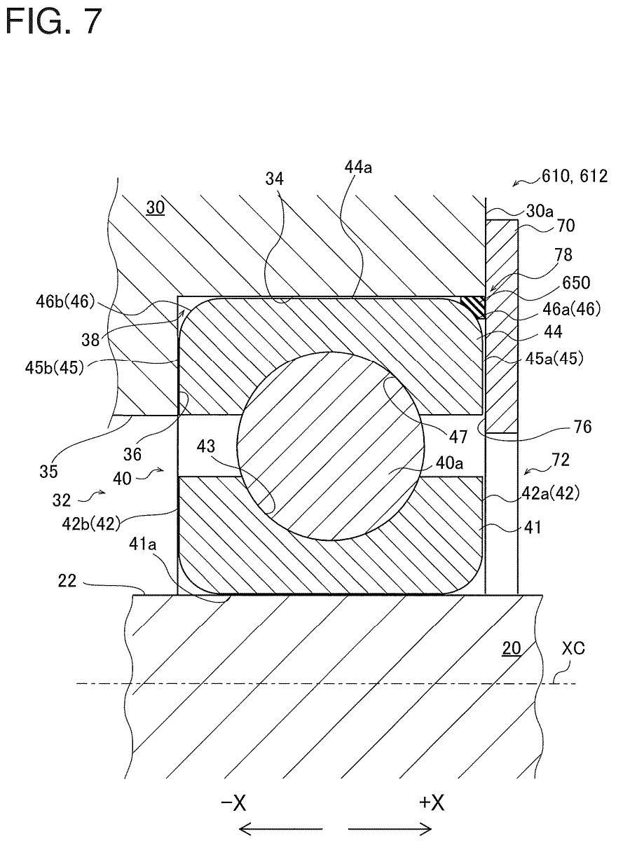

The vibration isolator in one or more embodiments of the disclosure may be a vibration isolator 650 in a vibration isolation structure 612 shown in FIG. 7. The vibration isolator 650 is located between the second corner 78 and the outer corner 46a of the bearing 40. More specifically, the vibration isolator 650 is received in a space defined by the larger-diameter portion 34 of the support 30, the engaging surface 76 of the fixture 70, and the outer corner 46a.

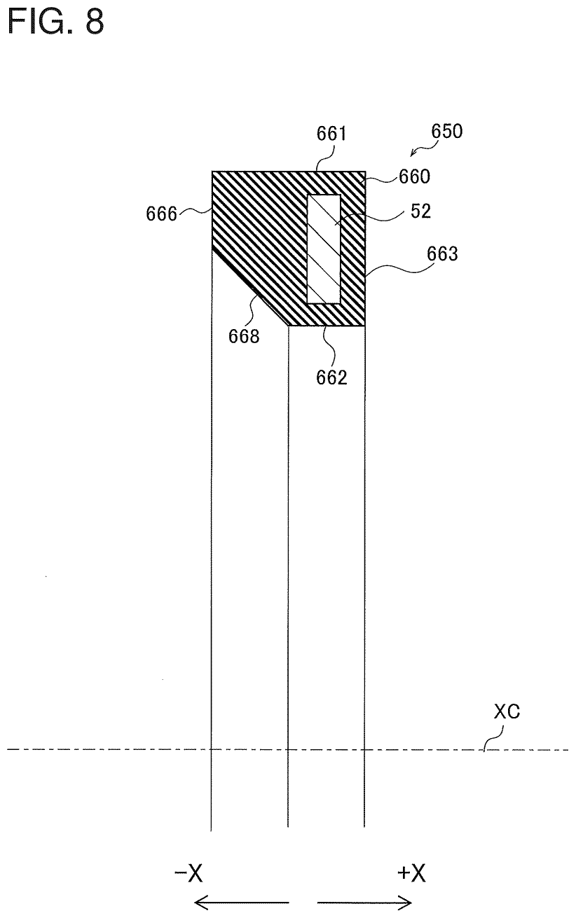

The vibration isolator 650 is annular and in an orientation axially opposite from the orientation of the vibration isolator 50 in the vibration isolation structure 12. The vibration isolator 650 includes, as shown in FIG. 8, an outer circumferential portion 661, an inner circumferential portion 662, a bottom 663, a distal end 666, and a slope 668. The outer circumferential portion 661 corresponds to the outer circumferential portion 61 of the vibration isolator 50, and the inner circumferential portion 662 corresponds to the inner circumferential portion 62 of the vibration isolator 50.

The bottom 663 connects the end of the outer circumferential portion 661 and the end of the inner circumferential portion 662 in the positive X-direction. The bottom 663 faces in the positive X-direction. The bottom 663 is in contact with the engaging surface 76 of the fixture 70.

The distal end 666 extends radially inward from the end of the outer circumferential portion 661 in the negative X-direction. The distal end 666 faces in the negative X-direction. The distal end 666 is shorter than the bottom 663 in the radial direction.

The slope 668 is a sloping surface connecting the distal end 666 and the inner circumferential portion 662. The slope 668 linearly slopes with respect to the axial direction in a cross-sectional view. The slope 668 faces radially inward and in the negative X-direction. The slope 668 faces and is in contact with the outer corner 46a of the bearing 40. The slope 668 is an example of a facing surface.

As in the vibration isolation structure 12, applying an elastic force from the vibration isolator 650 to the outer ring 44 reduces an internal clearance of the bearing 40 in the vibration isolation structure 612. In particular, under a load applied to the inner ring 41 in the positive X-direction through the shaft 20 and an elastic force applied to the outer ring 44, the internal clearance of the bearing 40 decreases in the vibration isolation structure 612.

The slope 668 is in contact with the outer ring 44 in the bearing 40.

The vibration isolation structure 612 can thus reduce, similarly to the vibration isolation structure 12, transmission of vibration from the bearing 40 located between the shaft 20 and the support 30 and reduce the misalignment of the rotation axis of the bearing 40 with a simple structure. The vibration isolation structure 612 allows the vibration isolator 650 to be attached in contact with the bearing 40 after the bearing 40 is fitted into the larger-diameter portion 34. In other words, the vibration isolation structure 612 allows the vibration isolator 650 to be adjusted relative to the bearing 40 fitted in the larger-diameter portion 34 before attachment.

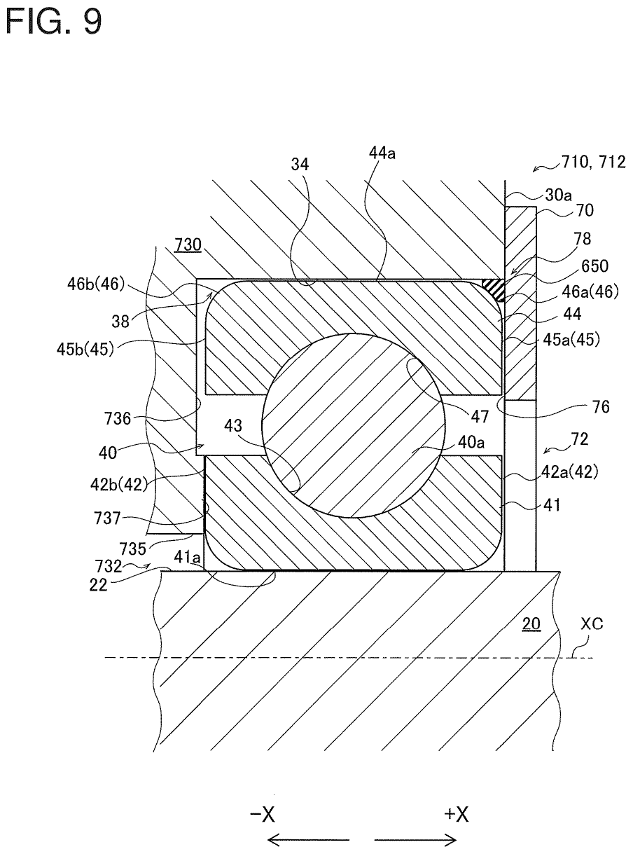

For the vibration isolator located between the second corner 78 and the outer corner 46a of the bearing 40, the vibration isolation structure according to one or more embodiments of the disclosure may be a vibration isolation structure 712 shown in FIG. 9 including the support with the first facing portion in contact with the inner end face 42b of the bearing 40. The details of the vibration isolation structure 712 will be described below. For the vibration isolation structure 712, the same components as the vibration isolation structure 12 or the vibration isolation structure 612 described above will be described using the same reference numerals and names of the components.

The vibration isolation structure 712 includes a support 730 in place of the support 30 in the vibration isolation structure 612. The support 730 has a hole 732 in place of the hole 32 in the support 30. The hole 732 includes a smaller-diameter portion 735 and a step surface 736 in place of the smaller-diameter portion 35 and the step surface 36 of the hole 32.

The smaller-diameter portion 735 has a smaller-diameter than the smaller-diameter portion 35 of the hole 32.

The step surface 736 is between the larger-diameter portion 34 and the smaller-diameter portion 735. The step surface 736 faces in the positive X-direction. With the bearing 40 received in the hole 732, the step surface 736 faces the outer end face 45b and the inner end face 42b. The step surface 736 is an example of the first facing portion. The step surface 736 includes a protrusion 737.

The protrusion 737 is on the radially inward edge of the step surface 736 and protrudes toward the bearing 40 from the step surface 736. The protrusion 737 faces in the positive X-direction. The protrusion 737 connects to the smaller-diameter portion 735. The protrusion 737 is in contact with the inner end face 42b of the bearing 40. In other words, the protrusion 737 on the step surface 736 is in contact with only the inner end face 42b.

A lubricator may be located between the protrusion 737 and the inner end face 42b of the bearing 40. The protrusion 737 may be a lubricator on the step surface 736. The lubricator may be, for example, a solid member formed from a solid lubricant or a resin, or may be a thrust bearing. The lubricator may be, for example, a lubricant such as grease or oil.

With the protrusion on the step surface in contact with the inner end face of the bearing as in the vibration isolation structure 712, the bearing may be a tapered rolling bearing or an angular ball bearing.

In the vibration isolation structure 712, the protrusion 737 on the step surface 736 is in contact with only the inner end face 42b as described above. An elastic force applied from the vibration isolator 650 to the outer ring 44 is transmitted from the outer ring 44 to the protrusion 737 through the rolling elements 40a and the inner ring 41 as an external force in the negative X-direction. In response to the external force transmitted from the inner ring 41 in the bearing 40 to the protrusion 737, the protrusion 737 applies a reaction force to the inner ring 41 in the positive X-direction based on the external force transmitted to the protrusion 737. The elastic force applied from the vibration isolator 650 to the outer ring 44 and the internal force applied from the protrusion 737 to the inner ring 41 further reduce the internal clearance of the bearing 40.

The vibration isolation structure 712 can thus more effectively reduce the misalignment of the rotation axis of the bearing 40.

Although the embodiments are described above as examples of the present invention, the present invention is not limited to the above embodiments, and may be altered, changed, or modified in various manners within the scope of its technical idea.

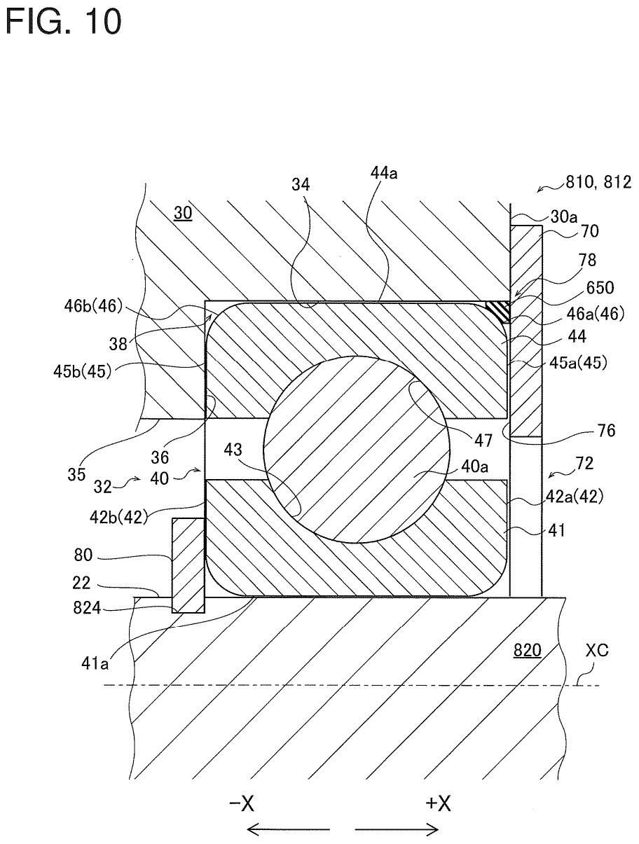

In the vibration isolation structure 12 according to the embodiments, the inner ring 41 in the bearing 40 is in contact with only the shaft 20 and the rolling elements 40a. However, in a vibration isolation structure 812 shown in FIG. 10, the inner ring 41 in the bearing 40 may be in contact with a restrictor 80 on a shaft 820 to restrict the position of the inner ring 41 relative to the shaft 820 in the axial direction.

The vibration isolation structure 812 includes the shaft 820 in place of the shaft 20 in the vibration isolation structure 612. The vibration isolation structure 812 further includes the restrictor 80, unlike the vibration isolation structure 612. The vibration isolation structure 812 includes the vibration isolator 650, similarly to the vibration isolation structure 612.

The shaft 820 includes a positioning groove 824, unlike the shaft 20. The positioning groove 824 is an annular recess that is open on the side surface 22 of the shaft 820. The positioning groove 824 is located in the negative X-direction from the bearing 40. The positioning groove 824 is located opposite to the vibration isolator 650 from the bearing 40 in the axial direction.

The restrictor 80 is a retaining ring received in the positioning groove 824. The restrictor 80 is integrally rotatable with the shaft 820 about the axis XC. The restrictor 80 is located opposite to the vibration isolator 650 from the bearing 40 in the axial direction. The restrictor 80 protrudes from the side surface 22 of the shaft 820. The restrictor 80 is in contact with the inner end face 42b of the bearing 40. The restrictor 80 is out of contact with the hole 32 in the support 30 and the outer ring 44 in the bearing 40. In other words, the restrictor 80 is in contact with the inner end face 42b of the inner ring 41. The restrictor 80 restricts the position of the bearing 40 relative to the shaft 820. The restrictor 80 restricts the position of the bearing 40 in the vibration isolation structure 812.

The vibration isolation structure 812 can further effectively reduce the misalignment of the rotation axis of the bearing 40 in the same manner as the vibration isolation structure 712.

The restrictor in one or more embodiments of the disclosure is not limited to a retaining ring. The restrictor may be, for example, a projection integral with the shaft 20 and protruding from the side surface 22.

For the vibration isolation structure according to one or more embodiments of the disclosure including a shaft with a restrictor, the support may have a hole with no smaller-diameter portion or facing portion, or neither of them in a direction opposite to the vibration isolator from the rolling bearing.

What is claimed is:

1. A vibration isolation structure, comprising:
a shaft extending in an axial direction;
a rolling bearing including
an inner ring fitted on the shaft, the inner ring including an inner end face facing in the axial direction, and
an outer ring located radially outward from the inner ring, the outer ring including
an outer end face facing in the axial direction,
an outer diameter portion facing radially outward, and
an outer corner connecting the outer diameter portion and the outer end face;
a support supporting the rolling bearing, the support including
a fitting portion fitted on the outer ring, and
at least one facing portion facing the inner end face or the outer end face; and
a vibration isolator being annular and received in a space defined by the fitting portion, the at least one facing portion, and the outer corner, the vibration isolator being in contact with the outer corner and applying an elastic force acting in a radial direction and in the axial direction to the outer ring.

2. The vibration isolation structure according to claim 1, wherein
the vibration isolator includes
an annular core, and
a body surrounding the annular core.

3. The vibration isolation structure according to claim 1, wherein
the vibration isolator has a facing surface facing the outer corner.

4. The vibration isolation structure according to claim 1, wherein
the outer corner is a chamfer.

5. The vibration isolation structure according to claim 1, wherein
the vibration isolator is integral with the outer ring.

6. The vibration isolation structure according to claim 1, further comprising:
an undercut between the fitting potion and the facing portion.

7. The vibration isolation structure according to claim 1, wherein
the at least one facing portion includes
a first facing portion located in a first axial direction from the rolling bearing, and
a second facing portion located in a second axial direction from the rolling bearing, the second axial direction being opposite to the first axial direction,
the second facing portion is an engaging surface of a fixture on the support, and the fixture is separate from the fitting portion, and
the vibration isolator is between the fitting portion and the second facing portion.

8. The vibration isolation structure according to claim 7, wherein
the first facing portion is in contact with only the inner end face of the inner ring.

9. The vibration isolation structure according to claim 1, wherein
the shaft further includes a restrictor located opposite to the vibration isolator from the rolling bearing in the axial direction, and the restrictor restricts a position of the rolling bearing relative to the shaft.

10. The vibration isolation structure according to claim 2, wherein
the vibration isolator has a facing surface facing the outer corner.

11. The vibration isolation structure according to claim 2, wherein
the outer corner is a chamfer.

12. The vibration isolation structure according to claim 3, wherein
the outer corner is a chamfer.

13. The vibration isolation structure according to claim 2, wherein
the vibration isolator is integral with the outer ring.

14. The vibration isolation structure according to claim 3, wherein
the vibration isolator is integral with the outer ring.

15. The vibration isolation structure according to claim 4, wherein
the vibration isolator is integral with the outer ring.

16. The vibration isolation structure according to claim 2, further comprising:
an undercut between the fitting potion and the facing portion.

17. The vibration isolation structure according to claim 3, further comprising:
an undercut between the fitting potion and the facing portion.

18. The vibration isolation structure according to claim 4, further comprising:
an undercut between the fitting potion and the facing portion.

19. The vibration isolation structure according to claim 5, further comprising:
an undercut between the fitting potion and the facing portion.

20. The vibration isolation structure according to claim 2, wherein
the at least one facing portion includes
a first facing portion located in a first axial direction from the rolling bearing, and
a second facing portion located in a second axial direction from the rolling bearing, the second axial direction being opposite to the first axial direction,
the second facing portion is an engaging surface of a fixture on the support, and the fixture is separate from the fitting portion, and
the vibration isolator is between the fitting portion and the second facing portion.
